(19) United States
(12) Patent Application Publication
(10) Pub. No.: US 2023/0107703 A1
(43) Pub. Date: Apr. 6, 2023

(54) SYSTEMS AND METHODS FOR AUTOMATED FRAUD DETECTION

(71) Applicant: THE TORONTO-DOMINION BANK, Toronto (CA)

(72) Inventors: Yanjun ZHANG, Toronto (CA); Yingqi WENG, Vaughan (CA)

(21) Appl. No.: 17/495,433

(22) Filed: Oct. 6, 2021

(51) Int. Cl. G06Q 20/40; G06N 20/00; G06Q 20/02

(52) U.S. Cl. CPC G06Q 20/4016; G06N 20/00; G06Q 20/02; G06Q 20/409

(57) ABSTRACT

Computer implemented methods and systems for automatically detecting whether transaction requests received at a computer system of an entity are fraud include receiving, at a machine learning model, inputs of historical and current transaction data, the model having been trained on the historical data including any fraud indications, determining and illustrating connections in a network graph including similarities between transactions in the new and historical transaction data based on overlap between values for the set of features for the transactions such that the links connecting the transactions in the nodes to show the overlap in features to define a relationship, the links further visually depicting which particular features from the set of features overlap in value between the transactions having the connections; and cluster the illustrated connections into defined groups and associate each cluster group as being either fraud transactions or non-fraudulent.

### FIELD

The present disclosure relates to systems and methods for automated fraud detection, and more particularly to using network analysis for detecting fraud.

### BACKGROUND

Fraud is one of the leading problems plaguing modern banks, and fraud prevention is a constantly evolving area. The ability to identify potentially fraudulent accounts in real-time and as they are created (e.g. bank applications submitted via a user computing device) is an important step to stopping fraudulent transactions before they happen. While banks have entire teams dedicated to fraud prevention, such manual reviews of applications can be erroneous, inefficient and time consuming. Existing systems are unable to identify, visualize and/or take action against potentially fraudulent actors in a quick, accurate and effective manner.

Additionally, a common manner of collecting and displaying account data upon the creation of an account is in the form of data tables. This approach makes it exceedingly difficult to visualize the data as there are vast quantities of information related to account openings making it exceedingly difficult to detect hidden patterns and insights therefrom. Finding connections in tabular data is even more difficult when some connections are subtle and not found in the information input by the user when submitting an application for the account.

Prior methods for capturing account data involving data tables made it difficult to capture complex relationships between the discrete data points. When connections are not readily available it becomes increasingly difficult to predict and capture potential fraud cases as the data is also dynamically changing.

Thus, there is a need for computerized systems and methods to present account data simply and efficiently to avoid wasting resources and provide fraud detection to address at least some of the above-mentioned shortcomings.

### SUMMARY

In at least some aspects, it is desirable to have a computerized system and method that provides the ability to view, in a simple and effective way, the connections and hidden relationships between various account data by a connected network graph. At least in some aspects, such systems use a machine learning fraud detection engine, having been trained with historical account data and any fraud data, which predicts and illustrates on a user interface of the computer system whether new application data may be fraudulent (e.g. which accounts are connected to known fraudulent accounts or associated with known suspicious activities) and enables ceasing transactions for the new application data or otherwise flagging the new application data as fraud for subsequent processing.

A system of one or more computers can be configured to perform particular operations or actions by virtue of having software, firmware, hardware, or a combination of the aforementioned components installed on the system that in operation cause or causes the system to perform the actions. One or more computer programs can be configured to perform particular operations or actions by virtue of including instructions that, when executed by data processing apparatus, cause the apparatus to perform the actions. One general aspect includes a computer system for automatically detecting whether transaction requests received at the computer system of an entity are fraud transactions and comprises: a computer processor; and a non-transitory computer-readable storage medium storage having instructions that when executed by the computer processor perform actions may include: receiving, at a machine learning model, a first input of historical transaction data relating to prior requests processed by the computer system, the historical transaction data including both approved transactions and fraud transactions, the machine learning model having been trained using the historical transaction data and the historical transaction data including a set of features defining the historical transaction data; receiving, at the machine learning model, a second input of new transaction data including the transaction requests, defined using a same set of features as the first input; in response to applying the inputs to the machine learning model, the machine learning model is configured to: determine connections between transactions in the new transaction data based on overlap between values for the set of features in the transactions; illustrate the connections in a graph, on a user interface of the computer system, between the transactions as a set of nodes for each transaction in the new transaction data and links connecting the transactions in the nodes to show the overlap in features to define a relationship, the links further visually depicting which particular features from the set of features overlap in value between the transactions having the connections; and cluster the illustrated connections into defined groups for being related to one another and associate each cluster group as being either fraud transactions or non-fraudulent transactions based on having trained the machine learning model on the historical transaction data. Other embodiments of this aspect include corresponding computer systems, apparatus, and computer programs recorded on one or more computer storage devices, each configured to perform the actions of the methods.

Implementations may include one or more of the following features. The system where each of the transaction requests relate to an application for opening an account for a new service or product with the entity. The set of features for the historical transaction data and the new transaction data relates to historical and new application data for opening the account, the data further may include: applicant profile data defining an applicant for each application; device profile data associated with a device submitting the transaction requests; geo-data associated with geographical information for each application; online account activity defining historical activity for each application; and authentication data authenticating a user submitting the transaction requests. The applicant profile data further may include but not limited to: name, email address and identification information for the applicant associated with a particular application. The device profile data may include but not limited to: type of device used for the application; device signature including IP address and version information of the device. The geo-data may include but not limited to: geographical information for where each of the transaction requests in the application data originates from and is processed. The authentication data further may include information relating to authenticating each application data via a third party web site for authenticating the applicant for the transaction request. The online account activity defines the historical activity on at least one of: how long an account has been opened for; whether it has fraud transactions associated with the application; and transaction velocity of the account. Implementations of the described techniques may include hardware, a method or process, or computer software on a computer-accessible medium.

One general aspect includes a non-transitory computer-readable storage medium may include instructions executable by a processor for automatically detecting whether transaction requests received at a computer system of an entity are fraud. The non-transitory computer-readable storage medium also includes receive, at a machine learning model, a first input of historical transaction data relating to prior requests processed by the computer system, the historical transaction data including both approved transactions and fraud transactions, the machine learning model having been trained using the historical transaction data and the historical transaction data including a set of features defining the historical transaction data; receive, at the machine learning model, a second input of new transaction data including the transaction requests, defined using a same set of features as the first input; in response to applying the inputs to the machine learning model, the machine learning model is configured to: determine connections between transactions in the new transaction data based on overlap between values for the set of features in the transactions; illustrate the connections in a graph, on a user interface of the computer system, between the transactions as a set of nodes for each transaction in the new transaction data and links connecting the transactions in the nodes to show the overlap in features to define a relationship, the links further visually depicting which particular features from the set of features overlap in value between the transactions having the connections; and cluster the illustrated connections on the user interface into defined groups for being related to one another and associate each cluster group as being either fraud transactions or non-fraudulent transactions based on having trained the machine learning model on the historical transaction data. Other embodiments of this aspect include corresponding computer systems, apparatus, and computer programs recorded on one or more computer storage devices, each configured to perform the actions of the methods.

One general aspect includes a computer implemented method of automatically detecting whether transaction requests received at a computer system of an entity are fraud. The computer implemented method also includes receiving, at a machine learning model, a first input of historical transaction data relating to prior requests processed by the computer system, the historical transaction data including both approved transactions and fraud transactions, the machine learning model having been trained using the historical transaction data and the historical transaction data including a set of features defining the historical transaction data; receiving, at the machine learning model, a second input of new transaction data including the transaction requests, defined using a same set of features as the first input; in response to applying the inputs, the machine learning model is configured to: determine connections between transactions in the new transaction data based on overlap between values for the set of features for the transactions; illustrate the connections in a graph between the transactions as a set of nodes for each transaction in the new transaction data and links connecting the transactions in the nodes to show the overlap in features to define a relationship, the links further visually depicting on the user interface which particular features from the set of features overlap in value between the transactions having the connections; and cluster the illustrated connections on the user interface into defined groups for being related to one another and associate each cluster group as being either fraud transactions or non-fraudulent transactions based on having trained the machine learning model on the historical transaction data. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features will become more apparent from the following description in which reference is made to the appended drawings wherein:

FIG. 1 shows an example network analysis engine, according to one embodiment;

FIG. 1A illustrates an example network topology in a network graph provided as output from the engine of FIG. 1, according to one embodiment;

FIG. 2 is a diagram illustrating an example computing device including the engine of FIG. 1, according to one embodiment;

FIG. 3 is a diagram illustrating an example output network graph (e.g. presented on a user interface of the computing device of FIG. 2) showing relationships between application account information, according to one embodiment;

FIG. 4 is a diagram illustrating another example of a portion of an output network graph (e.g. presented on a user interface of the computing device of FIG. 2) showing a detected fraud ring, according to one embodiment;

FIG. 5 is a diagram illustrating yet another example of an output network graph (e.g. presented on a user interface of the computing device of FIG. 2) showing a detected fraud ring, according to one embodiment; and

FIG. 6 is a flowchart illustrating example operations of a computing device, such as the computing device of FIG. 2, according to one embodiment.

### DETAILED DESCRIPTION

Generally, in at least some embodiments there is provided systems and methods that capture account related data samples from each user account and then visualizes these complex data samples in the form of a connected network of nodes representing account data and edges representing hidden relationships therebetween. Conveniently, in at least some aspects, this computerized and dynamic connected network allows simplified and easy viewing of various aspects of account information. These aspects include but are not limited to which accounts are valid, or normal, which accounts have anomalies or irregular data entries (e.g. indicate fraud), as well as which accounts may be connected to these irregular accounts or connected to known fraudulent accounts. In at least some aspects, this enhanced network visualization allows more efficient and accurate detection of fraud.

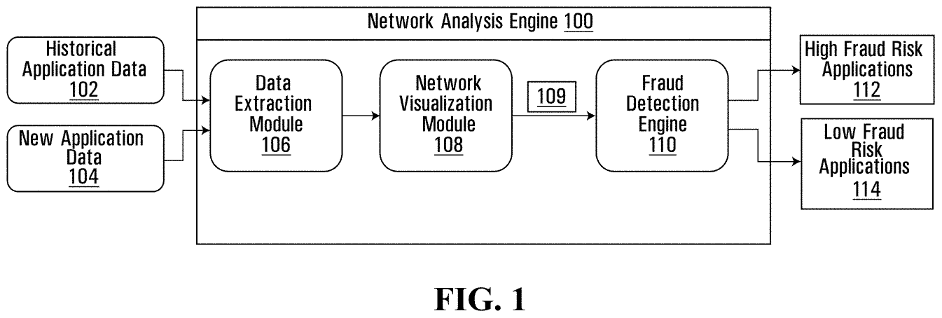

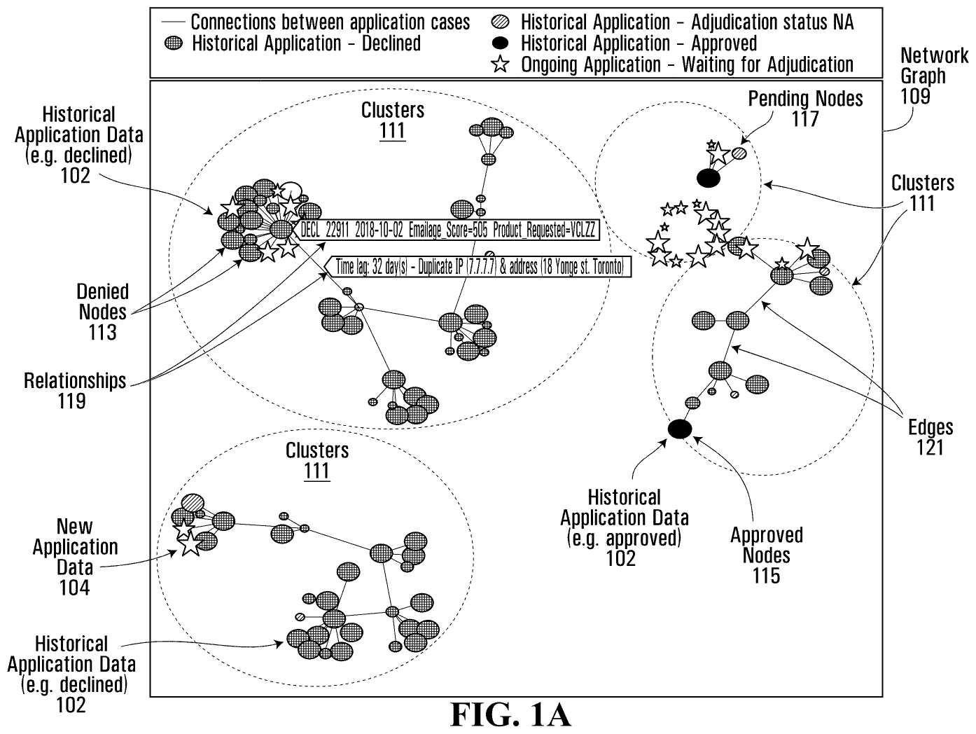

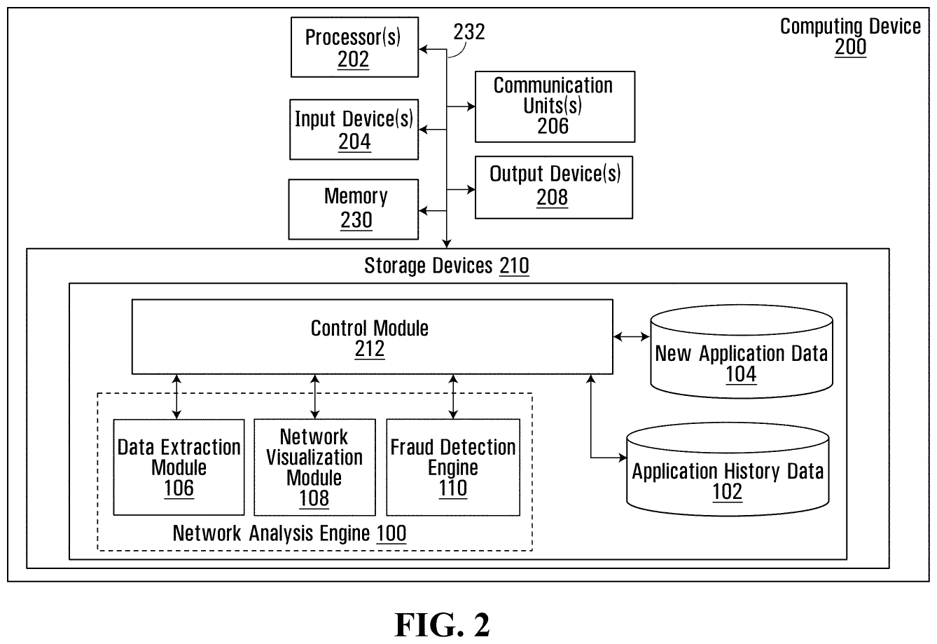

Referring to FIG. 1 shown is an example network analysis engine 100, according to one embodiment. In one embodiment, the network analysis engine 100 is configured for automatically presenting on a user interface of a computer, relationships and patterns between received transaction requests including application data information (e.g. historical application data 102) and using such to build a fraud detection engine 110 which utilizes supervised machine learning to detect fraud in new transaction requests for incoming applications (e.g. new application data 104). The network analysis engine 100 includes various modules and data stores for performing network analysis of application data, illustrating such networks and thereby performing fraud detection from network analysis visualizations based on a trained machine learning model for detecting fraud. At a high level, the network analysis engine 100 comprises a data extraction module 106, a network visualization module 108, a fraud detection engine 110, and data stores such as historical application data 102 and new application data 104. The historical application data 102 and new application data 104 may be received from another computing device across a communication network or at least partially input by a user at a computing device for the network analysis engine 100 (e.g. computing device 200 shown at FIG. 2).

The network analysis engine 100 may include additional computing modules or data stores in various embodiments. An example implementation of the engine 100 in a computing device is shown in FIG. 2 as the computing device 200. The network analysis engine 100 is configured for receiving transaction requests including historical application data 102 (e.g. historical account information including indications of which accounts have been previously tagged as fraud) and new application data as new application data 104; extracting relevant features of the data via the data extraction module 106; performing network analysis via the network visualization module 108 to generate a connected graph of the network representing the historical and new application data with the edges showing relationships between the data (e.g. network graph 109); and detecting fraud from the network analysis performed via a machine learning model based fraud detection engine 110 which applies clustering to the network graph 109 to determine potential fraud clusters (e.g. see clusters 111 in FIG. 1A). Referring to FIGS. 1 and 1A, the network visualization module 108 generates the network graph 109 in FIGS. 1 and 1A, which includes a visualization of approved nodes 115 (nodes for account data approved as unrelated to fraud) for historical applications; denied nodes 113 for historical applications (nodes for account data flagged as potential fraud); and pending nodes 117 for historical applications (nodes for account data that is unadjudicated). As also illustrated in FIG. 1A, if there is more than a defined degree of overlap or similarity between a set of application data in the nodes (e.g. sharing similar email addresses, sharing similarity in products requested, or other features relating to transaction requests for applications, etc.), edges 121 are generated between the nodes (e.g. sharing email address between nodes or other account data overlaps). Additionally, the network visualization module 108 may be configured to depict in textual format a high level summary of the relationship between nodes shown as relationship 119. Furthermore, the network visualization module 108 may be configured to perform clustering on the network graph 109 such as to define a set of connected node component clusters shown as clusters 111. In FIG. 1A, four example clusters are depicted (i.e. clusters 111). In at least some aspects, the fraud detection engine 110 having the machine learning model is trained based on prior application data including historical determinations of which items in the application data correspond to known fraud and associated metadata (e.g. as provided in the historical application data 102) to then predict fraud based on new application data provided (e.g. via new application data 104). Specifically, the fraud detection engine 110 reviews each of the visualized node clusters containing application data information represented in each node shown as clusters 111 in FIG. 1A and determines whether each cluster may be considered as high likelihood of fraud or low likelihood of fraud. Thus, in at least some aspects, such determination of fraud includes determining whether the data has more than a defined likelihood of fraud (e.g. categorized as high fraud risk applications 112) or a low likelihood of fraud (e.g. categorized as low fraud risk applications 114). This determination may further include analyzing the occurrence of fraud activity in each of the clusters 111 (e.g. number of occurrences, types of fraud, etc.) and thereby assigning each cluster to a fraudulent (e.g. high fraud risk applications 112) or non-fraudulent (e.g. low fraud risk applications 114) determination.

Thus, in at least some aspects, the network analysis engine 100 is configured to determine and illustrate (e.g. in the network graph 109), connectivity based on similarity of data between applications for accounts (e.g. associated with a merchant or financial institution) represented as nodes in the network graph 109 and use that to illustrate the relationships in the connectivity (e.g. via edges to show overlap between data in the nodes and a reasoning for links between the nodes). Such illustration or visualization of application data (e.g. historical application data 102 and new application data 104) and their connectivity relationships in the network graph 109 is then used by the network analysis engine 100 to assign the nodes in the graph to multiple clusters by clustering each set of connected nodes into a group and allocate whether each clustered group of nodes including any new application data held therein would likely to be fraud or non-fraudulent.

In at least some implementations of the present disclosure the process includes capturing application data points and displaying them in a visual network that displays connections between accounts both historical and current based on these data points.

Conveniently, in at least some aspects, by capturing more subtle data points, or “hidden information”, then visualizing the data points in a simplified connectivity network on a computerized user interface as may be provided by the computing device 200, it becomes easier to capture potential fraud cases.

As shown in FIG. 1, input data sources for the network analysis engine 100 may include historical application data 102 (e.g. containing a set of requests for account applications, any associated account information such as account holder information, email addresses assigned to the account holder, synthetic or actual identification, etc. as well as whether such historical applications were considered fraud or verified as non-fraudulent) and new requests for account openings and associated account metadata in new application data 104.

In at least some aspects, the historical application data 102 may include application and account data processed by the network analysis engine 100 and associated computing devices (e.g. computing device 200 in FIG. 2) in a prior time period such as from a present time to a past point in time. Such information may have been received or otherwise captured from one or more other computing devices connected to the computing device 200 for processing application information (e.g. merchant computing device or branch servers) and/or directly input to the computing device 200.

As illustrated in the example of FIG. 1A, historical application data 102 may include metadata for both applications that were approved (e.g. tagged as non-fraudulent) and applications that were flagged as potentially fraudulent. Generally, such applications being processed in the historical application data 102 may include applications requesting opening new account(s) such as a bank account, a credit card account, an insurance account, a merchant account, a loan application, a client account or other types of accounts for an offering entity. Such historical application data 102 may be used to train a machine learning based fraud detection engine 110 to predict fraudulent activity in data transactions including application requests received in the new application data 104 where the historical data to train the model for the fraud detection engine 110 includes transaction data for both the applications that were determined to be fraudulent (positive samples), and the applications that were confirmed to be non-fraudulent (negative samples). Thus the model for the fraud detection engine 110 is preferably trained with both positive and negative sample data so as not to introduce any bias to the training algorithm.

Referring again to FIG. 1, the data extraction module 106 is configured to extract key attributes from the input application data (e.g. historical application data 102 and/or new application data 104). Such key attributes may be defined based on prior iterations of the network analysis engine 100 as being key contributors (e.g. based on determining contribution rates) to predicting fraud. Notably, the key extracted attributes of the application data are then fed into the network visualization module 108 for generating the network graph 109 containing nodes as corresponding values of the application data for the extracted attributes.

The data extraction module 106 extracts attributes from the input data including a set of defined attributes based on prior historical learning of the network analysis engine 100. Such key attributes extracted from the application data may include but are not limited to: applicant profile defining what applicant information is entered in the application, including applicant name, email address, home address, application ID number, etc. Key attributes to be extracted may further include device profile information for the device associated with the application request such as the device type submitting the application request, the device signature (including the hardware and software of that device, the device's IP address, as well as version information of that device). Other key attributes which may be extracted via the data extraction module 106 include geographical data such as location data associated with computing devices providing the application request information from the application address, as well as information about where the application was sent from.

Other examples of key attributes include online account activity such as historical information unique to that device. This data may include information on how long the account has been open, whether it has historical fraud transactions, the transaction velocity of fraud, how frequently the account transacts, how much money the account has defrauded or not defrauded, etc. Other examples of key attributes may include features on behavioural patterns of dormant accounts that become active such as a dormant fraud account which may be quiet for a few months and then receive an e-money transfer. Other examples of key attribute information includes extensions to third parties such as authentication data in social media accounts, etc. and other third party sites. In at least some aspects, the authentication data further comprises information relating to authenticating each application data via a third party web site for authenticating the applicant for the transaction request.

In some aspects, the key features of the application data further capture online account activity data which defines the historical activity on at least one of: how long an account has been opened for; whether it has fraud transactions associated with the application; and transaction velocity of the account.

The key attributes captured may also include biometric data for the applicant and data on how long an applicant associated with the application spends on a particular website such as by monitoring cursor movement speed, etc.

Once the key attributes are extracted from the input application data, the application data values for such features may then be input into the network visualization module 108. The network visualization module 108 then performs two tasks. First to identify connections between the data (e.g. more specifically attributes in the data illustrated as nodes on a network graph 109), and secondly to present or illustrate on a user interface of an associated computing device the connections and relationships between the application data (e.g. shown as edges 121 and relationships 119 in FIG. 1A). Such illustration includes generating links between the nodes in the network graph having a relationship therebetween and in some aspects, a textual description of a nature of the relationship between the nodes (e.g. shared commonalities of attributes such as email address, shared applicant profile information, shared device information, etc.).

Thus, to identify the connections, the network visualization module 108 may first be configured to perform a cascading search of all of the unconnected information (e.g. new application data 104 which may have been newly received) input into the network analysis engine 100 in order to identify the various interconnections between the various aspects of features of the application data (e.g. historical application data 102 and new application data 104). As shown in FIG. 1A, this data may be visualized as nodes (e.g. approved nodes 115, pending nodes 117, denied node 113). In some examples, the application data (e.g. historical application data 102 and/or new application data 104) from different submissions or different requests may not be directly connected, so if application case A for a first application is the source of fraud, and application case A is connected to application case B for a second application which is connected to application case C for a third application and application case D for a fourth application, then the network visualization module 108 may be configured to create connections or links between A, B, C and D, shown by way of example as edges 121 in FIG. 1A. In some aspects, the network visualization module 108 may be defined with a cut-off so as not to overextend the connections.

The network visualization module 108 may further graphically visualize on a computerized user interface these connections in the form of a network of interconnected nodes (e.g. the network graph 109 illustrated in FIGS. 1 and 1A).

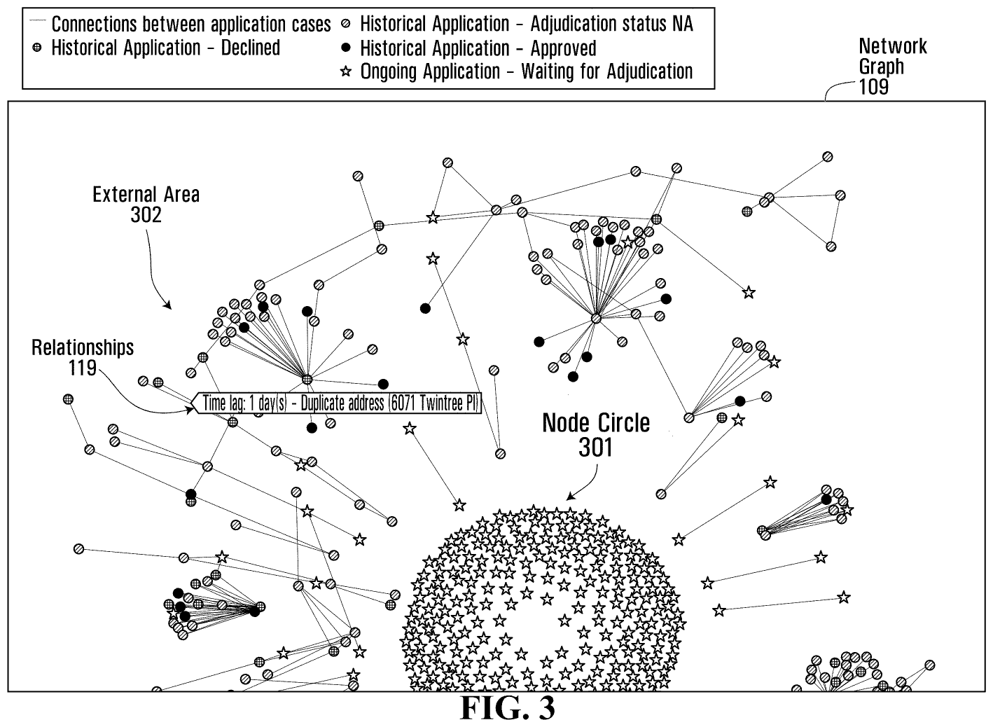

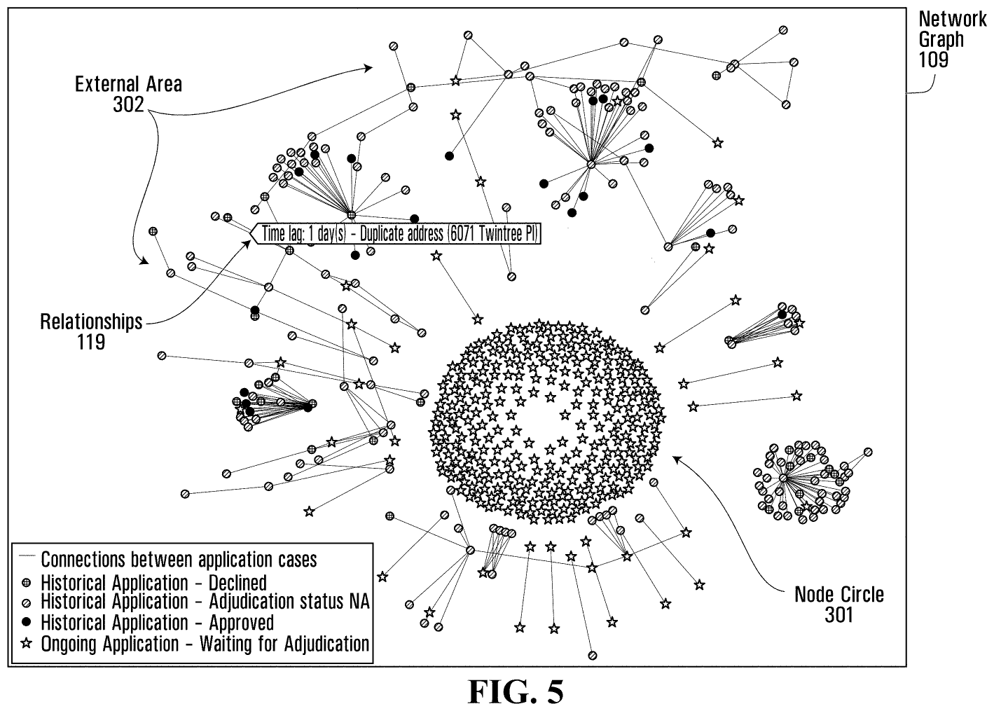

In other examples of the network graph 109 shown in FIGS. 3 and 5, within the final visualized network of nodes including historical and current application data, there may be a large circle containing a set of ongoing application nodes located in the middle of the graph, shown as a node circle 301 which represents the norm — or the accounts unlikely to be fraudulent. Any outlier nodes outside of that center cluster (and thus differ by more than a defined degree from the norm) such as that located in the external area 302 may be considered potentially fraudulent accounts, and there will often be large sub-networks of potentially fraudulent nodes. As illustrated in FIGS. 3 and 5, such external area 302 of nodes outlying the clustered area of nodes may generally define a fraud ring of nodes around a main cluster of nodes in the node circle 301, such ring of nodes in the external area 302 may then be flagged as potentially fraudulent by the fraud detection engine 110. In some example embodiments, such outlier cluster of nodes may be flagged as the high fraud risk applications 112 that may result in flagging the computing device associated with the network analysis engine 100 or other associated computing device to stop those transactions and any subsequent transactions having feature data associated with the transactions flagged as fraud. Such clustering of groups of nodes to define multiple clusters of application data nodes from the network graph 109 may be performed via the fraud detection engine 110.

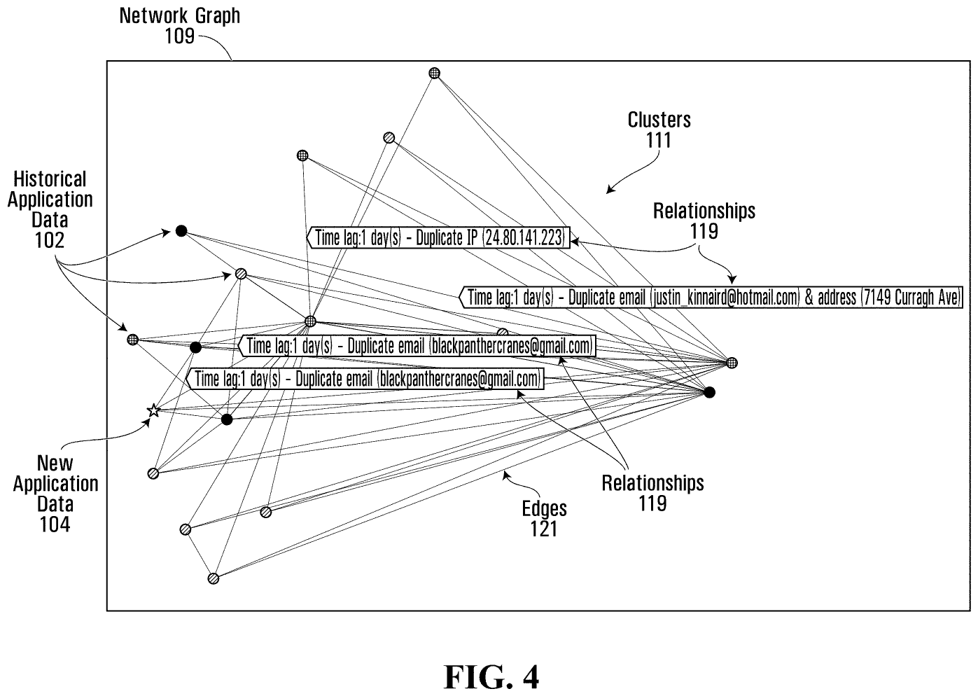

FIG. 4 illustrates yet another example of a network graph 109 generated by the network visualization module 108 shown in FIGS. 1 and 3. In the example of FIG. 4, the historical application data 102 and the new application data 104 is mapped onto the network diagram with the nodes representing attributes of the application data and links or edges 121 showing overlap of information between the nodes along with the relationships 119 (see for example relationships of shared information such as shared email address, shared home address or shared IP address associated with the application submission information). The example of FIG. 4 is a diagram illustrating a zoomed in portion of the fraud ring identified in the external area 302 of FIG. 3, such an outlier portion may be grouped together by fraud detection engine 110 in the clusters 111 as being high fraud risk applications 112.

FIG. 2 illustrates example computer components of an example computing device, such as a computing device 200 for providing the network analysis engine 100 described with respect to FIG. 1, in accordance with one or more aspects of the present disclosure, for example, for analyzing application transactions such as new application request data provided in the new application data 104 in relation to historical application data 102 and illustrating the data interactions with prior application transactions and other current transactions including similarity in the application data in a networked graph diagram (e.g. network graph 109) such as to detect whether transactions may be fraudulent or non-fraudulent.

Notably, the computing device 200 is configured via the network analysis engine 100 to apply network analysis to identify hidden connections and likeness of data between incoming applications (e.g. new application data 104) and historical applications (e.g. historical application data 102) including those which are previously confirmed to be fraud.

Examples of overlapping data connections between the application data nodes in the network graph 109 may include: home address, email account, IP address, device information, or other aspects of the data attributes.

The computing device 200 comprises one or more processors 202, one or more input devices 204, one or more communication units 206, one or more output devices 208 (e.g. providing one or more graphical user interfaces on a screen of the computing device 200) and a memory 230. Computing device 200 also includes one or more storage devices 210 storing one or more computer modules such as the network analysis engine 100, a control module 212 for orchestrating and controlling communication between various modules and data stores of the network analysis engine 100, historical application data 102 and new application data 104.

Communication channels 232 may couple each of the components including processor(s) 202, input device(s) 204, communication unit(s) 206, output device(s) 208, memory 230, storage device(s) 210, and the modules stored therein for inter-component communications, whether communicatively, physically and/or operatively. In some examples, communication channels 232 may include a system bus, a network connection, an inter-process communication data structure, or any other method for communicating data.

One or more processors 202 may implement functionality and/or execute instructions within the computing device 200. For example, processors 202 may be configured to receive instructions and/or data from storage devices 210 to execute the functionality of the modules shown in FIG. 2, among others (e.g. operating system, applications, etc.). Computing device 200 may store data/information (e.g. application related data, prior application data, historical predictions of whether application data has been linked to fraud or non-fraudulent) to storage devices 210. Some of the functionality is described further herein below.

Generally, the computing device 200 may be configured via the network analysis engine 100 to create and present on a user interface of the device 200, a network topology or the network graph 109 (e.g. see FIGS. 1 and 1A) including every one of application cases represented as nodes on the graph as provided in the historical application data 102 and new application data 104. As described earlier, the network analysis engine 100 is configured to conduct analysis on historical application nodes provided by the historical application data 102 and determine possible connections with new or upcoming applications provided in the new application data 104 including information about any links connecting the nodes such as the density of connection linkages, the number of connections each application data node has and reasons for the connectivity which may be displayed in the relationships 119 on the network graph 109 as displayed in FIGS. 1A, 4 and 5 by way of examples. Once the connectivity between the nodes is determined, the network visualization module 108 may further group the nodes in the network graph 109 into clusters based on the proximity of each node to a center of the cluster. An example of such clusters 111 is shown in FIG. 1A. From these clusters, the network analysis engine 100 determines, via a trained fraud detection engine 110 whether each cluster and the nodes contained therein should be classified as fraudulent or non-fraudulent. From this, the fraud detection engine 110 may generate a list of transaction requests and corresponding applications with high likelihood of being fraudulent (e.g. high fraud risk applications 112). For example, clusters may be assigned as being fraudulent based on having more than a defined degree of known prior fraud transactions in the clusters and connections either directly or indirectly from the current transactions in the new application data 104 to the prior fraud transactions. In other aspects, although there may not be a link between the current application data (e.g. new application data 104) and prior application data (e.g. historical application data 102) which may be known as fraud, such data may have been clustered together by way of having at least some similarity in the underlying data and thus related.

One or more communication units 206 may communicate with external computing devices via one or more networks by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 232).

The one or more storage devices 210 may store instructions and/or data for processing during operation of the computing device 200. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable read-only memory (EPROM) or electrically erasable and programmable read-only memory (EEPROM).

The computing device 200 may include additional computing modules or data stores in various embodiments. Additional modules, data stores and devices that may be included in various embodiments may be not be shown in FIG. 2 to avoid undue complexity of the description.

Other examples of computing device 200 may be a tablet computer, a person digital assistant (PDA), a laptop computer, a tabletop computer, a portable media player, an e-book reader, a watch, a customer device, a user device, or another type of computing device.

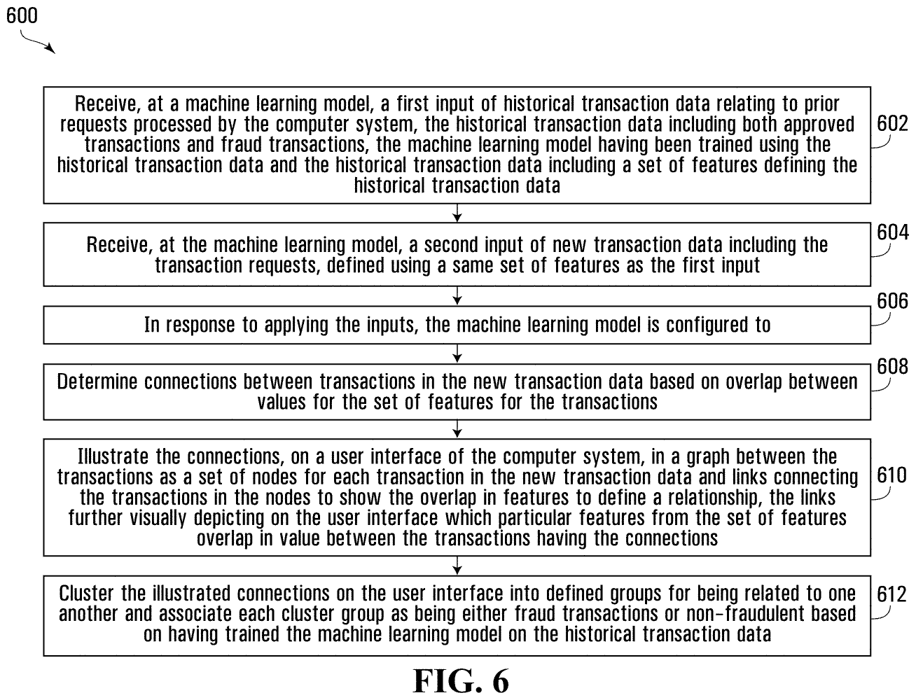

FIG. 6 illustrates a flow of exemplary operations of the network analysis engine 100 for detecting whether transaction requests received at the computer system of an entity are fraud illustrated in FIGS. 1 and 2 which may be implemented by a computing device such as the computing device 200.

At operation 602, the operations of the network analysis engine 100 include receiving, at a machine learning model (e.g. the network analysis engine 100 including a machine learning model such as in the fraud detection engine 110 and/or network visualization module 108), a first input of historical transaction data (e.g. historical application data 102) relating to prior requests processed by the computer system, the historical transaction data including both approved transactions and fraud transactions, the machine learning model having been trained using the historical transaction data (e.g. historical application data 102) and the historical transaction data including a set of features (e.g. application opening account information, client profile, merchant profile, type of account, associated computing devices, etc.) defining the historical transaction data.

At operation 604, the operations of the network analysis engine 100 further including receiving, at the machine learning model, a second input of new transaction data (e.g. new application data 104) as shown in FIG. 1, including the transaction requests for new applications, defined using a same set of features as the first input. As mentioned above, in some aspects, the data extraction module 106 may be configured to extract similar set of features from the historical application data 102 and the new application data 104 so that the application data held therein may be easily compared when provided to the network visualization module 108.

At operation 606, in response to applying the inputs to the machine learning model (e.g. see also FIGS. 1 and 2 as examples), the machine learning model (e.g. a combination of the network visualization module 108 and the fraud detection engine 110) is configured at operation 608 to determine connections between transactions in the new transaction data held in new application data 104 (and in some aspects, connections between transactions in the new transaction data held in the new application data 104 with each other and with the historical data in the historical application data 102) based on overlap between values for the set of features in the transactions. As described earlier, in at least some embodiments, the network visualization module 108 is configured to determine a degree of overlap or similarity between feature values for the transactions which may include current and past transactions such as the example in FIG. 1A showing that nodes can share information and the relationships may be shown as relationships 119.

At operation 610, the model (e.g. provided by the network visualization module 108) is configured to illustrate the connections, on a user interface (e.g. output devices 208 in FIG. 2) of the computing device, in a graph (e.g. the network graph 109 illustrated in FIGS. 1A, 4-5) between the transactions as a set of nodes for each transaction in the new transaction data and links (e.g. edges 121) connecting the transactions in the nodes to show the overlap in features to define a relationship, the links further visually depicting on the user interface which particular features from the set of features overlap in value between the transactions having the connections (e.g. see relationships 119 in FIG. 1A, 4 and 5 showing textual depiction of the relationship between the nodes and a reasoning including the attributes and attribute values shared between the nodes.

At operation 612, operations of the network analysis engine 100 and notably the network visualization module 108 and fraud detection engine 110 cluster the illustrated or visualized connections on the user interface into defined groups for being related to one another (e.g. see FIG. 1A depicting clusters 111) and associate each cluster group as being either fraud transactions (e.g. high fraud risk applications 112 in FIG. 1) or non-fraudulent (e.g. low fraud risk applications 114 in FIG. 1) based on having trained the machine learning model (e.g. the network visualization module 108 and/or the fraud detection engine 110) on the historical transaction data. As illustrated earlier, in some implementations, the fraud detection engine 110 may be configured to classify one main cluster of applications as being non-fraudulent as shown in the node circle 301 of FIG. 3 (e.g. a depiction of the user interface output provided by the computing device 200 of FIG. 2) and the outlying transactions as fraudulent as they lack a degree of similarity to the main cluster.

In some aspects, of the operation 612 associating each cluster group (e.g. the clusters 111) as being either fraud transactions or non-fraudulent transactions further includes the fraud detection engine 110 being trained to determine a number of occurrences of fraudulent nodes in the historical transaction data (e.g. historical application data 102) and a degree of connectivity between the new transaction data (e.g. new application data 104) and the fraudulent nodes to determine an overall indication of fraudulent (e.g. high fraud risk applications 112) or non-fraudulent data (e.g. low fraud risk applications 114).

In at least some aspects, the transaction requests included in the historical application data 102 and the new application data 104 relate to an application for opening an account for a service or product or other offering with the entity for which the transactions occur.

One or more currently preferred embodiments have been described by way of example. It will be apparent to persons skilled in the art that a number of variations and modifications can be made without departing from the scope of the disclosure as defined in the claims.

What is claimed is:

1. A computer system of an entity for automatically detecting whether transaction requests received at the computer system are fraud, the system comprising:
a computer processor; and a non-transitory computer-readable storage medium storage having instructions that when executed by the computer processor perform actions comprising:
receiving, at a machine learning model, a first input of historical transaction data relating to prior requests processed by the computer system, the historical transaction data including both approved transactions and fraud transactions, the machine learning model having been trained using the historical transaction data and the historical transaction data including a set of features defining the historical transaction data;
receiving, at the machine learning model, a second input of new transaction data including the transaction requests, defined using a same set of features as the first input;
in response to applying the inputs to the machine learning model, the machine learning model is configured to:
determine connections between transactions in the new transaction data based on overlap between values for the set of features in the transactions;
illustrate the connections in a graph, on a user interface of the computer system, between the transactions as a set of nodes for each transaction in the new transaction data and links connecting the transactions in the nodes to show the overlap in features to define a relationship, the links further visually depicting on the user interface which particular features from the set of features overlap in value between the transactions having the connections; and
cluster the illustrated connections on the user interface into defined groups for being related to one another and associate each cluster group as being either fraud transactions or non-fraudulent transactions based on having trained the machine learning model on the historical transaction data.

2. The system of claim 1, wherein each of the transaction requests relate to an application for opening an account for a new service or product with the entity.

3. The system of claim 2 wherein the set of features for the historical transaction data and the new transaction data relates to historical and new application data for opening the account, the data further comprises: applicant profile data defining an applicant for each application; device profile data associated with a device submitting the transaction requests; geo-data associated with geographical information for each application; online account activity defining historical activity for each application; and authentication data authenticating the applicant submitting the transaction requests.

4. The system of claim 3, wherein the applicant profile data further comprises: name, email address and identification information for the applicant associated with a particular application.

5. The system of claim 3, wherein the device profile data comprises: type of device used for the application; device signature including IP address and version information of the device.

6. The system of claim 3, wherein the geo-data comprises: geographical information for where each of the transaction requests in the application data originates from and is processed.

7. The system of claim 3, wherein the authentication data further comprises information relating to authenticating each application data via a third party web site for authenticating the applicant for the transaction request.

8. The system of claim 3, wherein the online account activity defines the historical activity on at least one of: how long an account has been opened for; whether the account has fraud transactions associated with the application; and transaction velocity of the account.

9. The system of claim 1, wherein associating each cluster group as being either fraud transactions or non-fraudulent transactions further includes the model being trained to determine a number of occurrences of fraudulent nodes in the historical transaction data and a degree of connectivity between the new transaction data and the fraudulent nodes to determine an overall indication of fraudulent or non-fraudulent.

10. A non-transitory computer-readable storage medium comprising instructions executable by a processor for automatically detecting whether transaction requests received at a computer system of an entity are fraud, the instructions comprising steps for the processor to:
receive, at a machine learning model, a first input of historical transaction data relating to prior requests processed by the computer system, the historical transaction data including both approved transactions and fraud transactions, the machine learning model having been trained using the historical transaction data and the historical transaction data including a set of features defining the historical transaction data;
receive, at the machine learning model, a second input of new transaction data including the transaction requests, defined using a same set of features as the first input;
in response to applying the inputs to the machine learning model, the machine learning model is configured to:
determine connections between transactions in the new transaction data based on overlap between values for the set of features in the transactions;
illustrate the connections in a graph, on a user interface of the computer system, between the transactions as a set of nodes for each transaction in the new transaction data and links connecting the transactions in the nodes to show the overlap in features to define a relationship, the links further visually depicting which particular features from the set of features overlap in value between the transactions having the connections; and
cluster the illustrated connections on the user interface into defined groups for being related to one another and associate each cluster group as being either fraud transactions or non-fraudulent transactions based on having trained the machine learning model on the historical transaction data.

11. A computer implemented method of automatically detecting whether transaction requests received at a computer system of an entity are fraud, the method comprising:
receiving, at a machine learning model, a first input of historical transaction data relating to prior requests processed by the computer system, the historical transaction data including both approved transactions and fraud transactions, the machine learning model having been trained using the historical transaction data and the historical transaction data including a set of features defining the historical transaction data;
receiving, at the machine learning model, a second input of new transaction data including the transaction requests, defined using a same set of features as the first input;
in response to applying the inputs, the machine learning model is configured to:
determine connections between transactions in the new transaction data based on overlap between values for the set of features for the transactions;
illustrate the connections in a graph, on a user interface of the computer system, between the transactions as a set of nodes for each transaction in the new transaction data and links connecting the transactions in the nodes to show the overlap in features to define a relationship, the links further visually depicting which particular features from the set of features overlap in value between the transactions having the connections; and
cluster the illustrated connections on the user interface into defined groups for being related to one another and associate each cluster group as being either fraud transactions or non-fraudulent transactions based on having trained the machine learning model on the historical transaction data.

12. The method of claim 11, wherein each of the transaction requests relate to an application for opening an account for a new service or product with the entity.

13. The method of claim 12 wherein the set of features for the historical transaction data and the new transaction data relates to historical and new application data for opening the account, the data further comprises: applicant profile data defining an applicant for each application; device profile data associated with a device submitting the transaction requests; geo-data associated with geographical information for each application; online account activity defining historical activity for each application; and authentication data authenticating the applicant submitting the transaction requests.

14. The method of claim 13, wherein the applicant profile data further comprises: name, email address and identification information for the applicant associated with a particular application.

15. The method of claim 13, wherein the device profile data comprises: type of device used for the application; device signature including IP address and version information of the device.

16. The method of claim 13, wherein the geo-data comprises: geographical information for where each of the transaction requests in the application data originates from and is processed.

17. The method of claim 13, wherein the authentication data further comprises information relating to authenticating each application data via a third party web site for authenticating the applicant for the transaction request.

18. The method of claim 13, wherein the online account activity defines the historical activity on at least one of: how long an account has been opened for; whether the account has fraud transactions associated with the application; and transaction velocity of the account.
